(19) United States
(12) Patent Application Publication
(10) Pub. No.: US 2010/0150040 A1
(43) Pub. Date: Jun. 17, 2010

(54) Wirelessly controlled idle power consumption management device for electronic products

(75) Inventor: Yung-Hao Huang, SanChung City (TW)

Correspondence Address: BACON & THOMAS, PLLC, 625 SLATERS LANE, FOURTH FLOOR, ALEXANDRIA, VA, 22314-1176, US

(73) Assignee: Michilin Prosperity Co., Ltd., SanChung City (TW)

(21) Appl. No.: 12/314,799

(22) Filed: Dec. 17, 2008

(51) Int. Cl. G08C 17/00

(52) U.S. Cl. 370/311

(57) ABSTRACT

This specification discloses a wirelessly controlled idle power consumption management device for electronic products. It comprises at least a wireless detector and a wireless remote control. Each of the wireless detectors has an AC plug and at least one power outlet for other electronics in the exterior and at least one microcontroller, at least one RF module and at least one electrical current detector in the interior. The wireless remote control also has at least one microcontroller and at least one RF module inside. When the wireless remote control and at least one wireless detector join together, the wireless remote control can simultaneously start several wireless detectors, making them detect whether an electronic product is in use or in an idle state. In the former case, the electrical power supply is maintained. In the latter case, the power supply to the electronic product is shut down after a certain time, reducing the idle power consumption thereof to zero.

### BACKGROUND OF THE INVENTION

1. Field of Invention

The invention relates to a power saving device and, in particular, to a wirelessly controlled idle power consumption detector for electronic products so that the idle power consumption detector automatically and completely shuts down the power supply to the electronic product when it is idle, rendering zero idle power consumption. Since the power is automatically shuts down, the invention reduces the danger of fire.

2. Related Art

Home electronic products are usually idle most of the time. These idle electronic products consume energy all the time, called idle power consumption. Such idle power consumption increases the monthly utility cost. Moreover, such power waste directly increases the unnecessary carbon production and exacerbates global warming.

Suppose billions of home electronics worldwide can be completely turned off automatically by some power consumption detector when they are not in use so that their idle power consumption is zero. Then the saved energy can greatly alleviates the global warming effect.

### SUMMARY OF THE INVENTION

In view of the foregoing, it is an objective of the invention to provide a wirelessly controlled idle power consumption management device for electronic products that automatically shuts down the electrical power of idle electronic devices, thereby diminishing idle power consumption and saving energy.

To achieve the above-mentioned objective, the disclosed wirelessly controlled idle power consumption management device comprises at least a wireless detector and a wireless remote control. Each of the wireless detectors has an AC plug and at least one power outlet for other electronics in the exterior and at least one microcontroller, at least one RF module and at least one electrical current detector in the interior. The wireless remote control also has at least one microcontroller and at least one RF module inside. When the wireless remote control and at least one wireless detector join together, the wireless remote control can simultaneously start several wireless detectors, making them detect whether an electronic product is in use or in an idle state. In the former case, the electrical power supply is maintained. In the latter case, the power supply to the electronic product is shut down after a certain time, reducing the idle power consumption thereof to zero.

### BRIEF DESCRIPTION OF THE DRAWINGS

The invention will become more fully understood from the detailed description given herein below illustration only, and thus is not limitative of the present invention, and wherein:

FIG. 1A and FIG. 1B are three-dimensional views of the disclosed wireless detector from different perspectives;

FIG. 2 is a three-dimensional view of the disclosed wireless remote control; and

FIG. 3 is a three-dimensional view of another embodiment of the disclosed wireless detector.

### DETAILED DESCRIPTION OF THE INVENTION

The present invention will be apparent from the following detailed description, which proceeds with reference to the accompanying drawings, wherein the same references relate to the same elements.

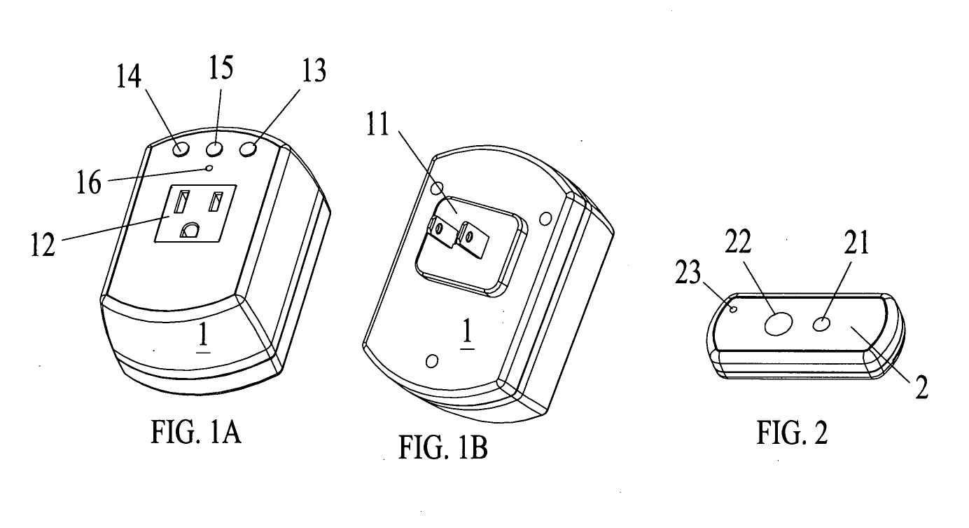

FIG. 1A and FIG. 1B are three-dimensional views of the disclosed wireless detector from different perspectives. FIG. 2 is a three-dimensional view of the disclosed wireless remote control.

Basically, the wireless detector 1 in FIG. 1 is a power socket base including a plug 11 to an AC wall outlet and a power outlet 12 for some other electronic product to plug in.

Inside the wireless detector 1, there are at least one microcontroller (MCU), at least one RF module using Zigbee or some other wireless communication protocol for wireless data transmission, and at least one electrical current detector. The Zigbee or some other wireless communication protocol has the feature of being suitable for short-distance (within 50 meters) communications, consuming little power, and having a simple structure.

Outside the wireless detector 1, there are at least a connect key 13, an idle power preset key 14, a manual ON key 15, and a signal indicator (an LED) 16. For the first time, the connect 13 and the connect key 21 of the remote control 2 have to be simultaneously pressed for several seconds to join. In the meantime, the signal indicator 16 flashes to indicate that a joining-is undergoing. After the joining is done, the wireless detector 1 is controlled by the wireless remote control 2. The operating method of the idle power preset key 14 is as follows. After an electronic product is plugged into the power outlet 12 of the wireless detector, one first does not use the electronic product (e.g., do not turn on a TV first). Instead, the user first presses the manual ON key and then the idle power preset key 14 for several seconds. In the meantime, the signal indicator 16 flashes to indicate a setting is undergoing. After the setting, once the TV is turned off, the wireless detector automatically turns off the power supply to the TV after a predetermined time, achieving the goal of saving energy. The manual ON key 15 is provided for the convenience of the user to start a particular wireless detector 1 without using the wireless remote control 2.

Each of the above-mentioned power socket bases can be equipped with a wireless detector. Each wireless detector has an independent identification (ID) so that individual wireless detectors can be accurately controlled without being interfered by other wireless remote controls or RF waves.

The interior of the wireless remote control 2 in FIG. 2 also includes at least one MCU and at least one RF module using Zigbee or some other wireless communication protocol for communications.

The exterior of the wireless remote control 2 has at least a connect key 21 an ON key 22, and a signal indicator (an LED) 23. In particular, the connect key 21 and the connect key 13 of the wireless detector have to be pressed for several seconds to join for the first time of use. In the meantime, the signal indicator 23 flashes to indicate that a joining is undergoing. After the joining is done, the wireless remote control 2 can control the wireless detector 1.

The ON key 22 is used to start the joined wireless detector 1. Once the ON key is pressed, all the wireless detectors 1 within the range of the wireless remote control 2 are started and the power to the electronic products are turned on. In this case, the wireless detector 1 has determined the idle power consumption parameters for the electronic products. Although individual wireless detectors 1 are turned on, each of them determines whether the corresponding electronic product is in use or in the idle state. In the former case, the power supply is continued. In the latter case, the power supply to the electronic product is automatically turned off, rendering zero idle power consumption for those electronic products.

The above-mentioned wireless remote control can be joined by several wireless detectors. They can all be turned on simultaneously.

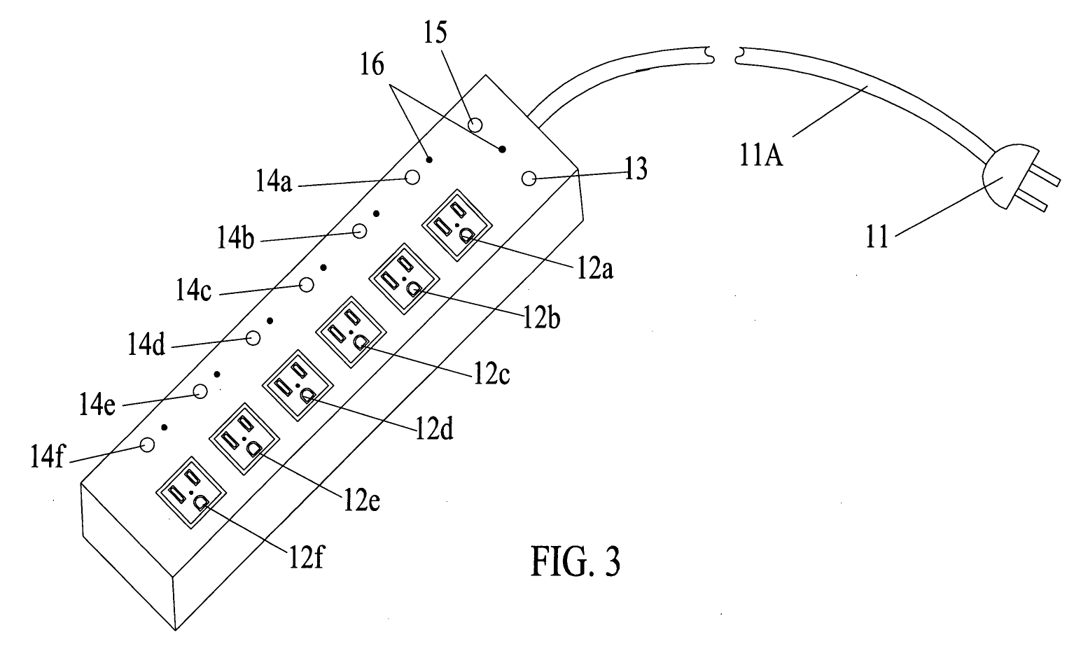

Please refer to FIG. 3 for the three-dimensional view of another embodiment of the disclosed wireless detector. The wireless detector 1 has an extension cord 11a and a plug 11 connected to a wall outlet and several power outlets 12a-12f for electronic products to plug in. The exterior of the wireless detector 1 has at least a connect key 13, a manual OK key 15, a signal indicator (an LED) 16, and idle power preset keys 14a-14f corresponding to the power outlets 12a-12f. Any of the power outlets 12a-12f or any of the idle power preset keys 14a-14f is equipped with an independent electrical current detector.

Home electronics are idle for most of the time. This is a waste of energy and increases the utility cost. To reduce energy waste, a conventional method is to unplug electronic products. However, sometimes the power outlet is located at some inconvenient place or corner so that unplugging is not easy. The combination of wireless detectors and wireless remote control can readily turn on or off the power of electronic products automatically. Besides, as the wireless detector can automatically monitor the usage state of an electronic product, it is convenient in management for the user. Moreover, the power outlets can be accurately controlled. Therefore, the invention can achieve the goals of automatic management and saving power. At the same time, the number of plugging and unplugging times can be reduced to elongate the lifetime of power outlets.

Here an example is provided to illustrate how the invention saves energy. A rough estimate of idle power consumption of home electronics is as follows:
1. TV (2 sets): 10 W×2=20 W (idle 19 hr/day)
2. Stereo, DVD: 5 W (idle 21 hr/day)
3. Computer and peripherals (including computer host, display, printer, scanner, etc): 45 W (idle 21 hr/day)
4. Microwave oven: 5 W (idle 23 hr/day)
5. Washing machine: 5 W (idle 22 hr/day)
6. Various chargers: 2 W (idle 20 hr/day)
7. Air conditioner (2 sets): 5 W×2=10 W (in use 12 hr/day)
8. Rice cooker: 5 W (22 hr/day)
9. Fan: 3 W (12 hr/day)
10. Dish washer: 5 W (22 hr/day)
11. Dish dryer: 5 W (22 hr/day)

Therefore, the daily idle power consumption totals: (20×19)+(5×21)+(45×21)+(5×23)+(5×22)+(2×20)+(10×12)+(5×22)+(3×12)+(5×22)+(5×22)=2181 W (2.181 KW). The monthly idle power consumption is 2181×30=65430 W (65.430 KW)=65.43 units of electrical power. The yearly idle power consumption is 6543×12=785160 W (785.160 KW)=785.160 units of electrical power.

Suppose each unit of electrical power is NT$3.465, the idle power consumption each year costs 785.16×3.465=NT$2720.58.

According to a formula of Taiwan Power Company (TPC), the wasted electrical power produces 500.728 kg of carbon dioxide.

Extrapolating the above calculation, the idle power consumption from a million families is 78,516,000 KW each year, producing 500,727.938 tons of carbon dioxide.

All these numbers indicate that when most idle power consumption in worldwide families is effectively reduced, the utility costs can be saved. More importantly, the global warming problem can be alleviated.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A wirelessly controlled idle power consumption management device for electronic products, comprising at least one wireless detector and at least one wireless remote control, wherein
the exterior of the wireless detector has a plug to plug in a wall outlet and a t least one power outlet for another electronic product to plug in, and the interior thereof has at least one microcontroller (MCU), at least one RF module, and at least one electrical current detector;
the interior of the wireless remote control includes at least one MCU and at least one RF module;
after the wireless remote control and at least one wireless detector join successfully, the wireless remote control simultaneously start several wireless detectors for each of the wireless detectors to automatically determine whether the corresponding electronic product is in use or idle state; and
electrical power is maintained if the electronic product is in use or is shut down after a specific delay time if the electronic product is idle, rendering zero idle power consumption.

2. The wirelessly controlled idle power consumption management device of claim 1, wherein the RF module uses Zigbee or some other wireless communication protocol for communications.

3. The wirelessly controlled idle power consumption management device of claim 1, wherein the exterior of the wireless detector has at least one connect key, at least one idle power preset key, at least one manual ON key, and at least one signal indicator.

4. The wirelessly controlled idle power consumption management device of claim 1, wherein the exterior of the wireless remote control has at least one connect key and at least one ON key.

5. The wirelessly controlled idle power consumption management device of claim 3 or 4, wherein the connect key of the wireless detector and the connect key of the wireless remote control are pressed simultaneously for a predetermined time to join together.

6. The wirelessly controlled idle power consumption management device of claim 5, wherein the signal indicator flashes when the connect key of the wireless detector and the connect jet of the wireless remote control are joining.

7. The wirelessly controlled idle power consumption management device of claim 3, wherein the manual OK key is first pressed and then the idle power preset key is pressed for a predetermined time for setting after plugging the electronic product into the power outlet of the wireless detector and before using the electronic product.

8. The wirelessly controlled idle power consumption management device of claim 7, wherein the signal indicator flashes when the idle power preset key performs settings.

9. The wirelessly controlled idle power consumption management device of claim 4, wherein after the ON key of the wireless remote control starts a wireless detector the electrical power supply to the electronic product plugged into the power outlet of the wireless detector is on and the wireless detector automatically determines whether the electronic product is in use of idle state so that the electrical power supply continues in the former case and is turned off after a specific delay time in the latter case, rendering zero idle power consumption.
